(19) United States
(12) Patent Application Publication
(10) Pub. No.: US 2025/0382906 A1
(43) Pub. Date: Dec. 18, 2025

(54) ENGINE

(71) Applicant: KUBOTA Corporation, Osaka-shi, Osaka (JP)

(72) Inventors: Kensuke FUJITA, Sakai-shi, Osaka (JP); Hiroki OSO, Sakai-shi, Osaka (JP); Rina KOMAGATA, Sakai-shi, Osaka (JP); Yoshiro TADA, Sakai-shi, Osaka (JP); Naotaro NAGAI, Sakai-shi, Osaka (JP); Yuki TAGASHIRA, Sakai-shi, Osaka (JP)

(21) Appl. No.: 19/100,336

(22) PCT Filed: Aug. 24, 2023
(86) PCT No.: PCT/JP2023/030515

§ 371 Date: Jul. 31, 2025

(30) Foreign Application Priority Data
Sep. 30, 2022 (JP) 2022-158089

(51) Int. Cl. F01M 1/08; F01M 11/02

(52) U.S. Cl. CPC F01M 1/08; F01M 11/02

(57) ABSTRACT

A shaft-less engine in which lubrication of a cam of a camshaft is not hindered when a cylinder block is shared by engines having different specifications and distinguished by presence or absence of a predetermined rotation shaft. A camshaft chamber front wall includes a front bearing hole of the camshaft and a front hole disposed below the front bearing hole, a camshaft chamber rear wall includes a rear hole concentric with the front hole, a cylinder block front wall includes an oil supply passage in which a passage outlet is formed on an inner peripheral surface of the front hole, a fitting component that covers the passage outlet of the oil supply passage is internally fitted into the front hole of the camshaft chamber front wall, and the fitting component includes a camshaft oil jet hole that injects engine oil from the oil supply passage to the camshaft.

### TECHNICAL FIELD

The present invention relates to an engine, and specifically to a shaft-less engine in which lubrication of a cam of a camshaft is not hindered in a case where a cylinder block is shared by engines having different specifications and distinguished by presence or absence of a predetermined rotation shaft.

### BACKGROUND ART

Conventionally, there is an engine in which a predetermined rotation shaft (governor shaft) is installed in a camshaft chamber (see, for example, Patent Document 1).

It is conceivable to manufacture a shaft-less engine without a predetermined rotation shaft (governor shaft) while sharing the same cylinder block as the shaft-equipped engine having the predetermined rotation shaft (governor shaft).

### PRIOR ART DOCUMENT

### Patent Document

Patent Document 1: Japanese Patent Application Laid-open No. 2005-83336 (see FIG. 1)

### SUMMARY OF THE INVENTION

### Problems to be Solved by the Invention

<<Problems>> In a shaft-less engine, lubrication of the cam of the camshaft could be hindered.

In a case where a shaft-less engine is manufactured as described above, engine oil cannot be splashed up by the predetermined rotation shaft (governor shaft). Thus, oil mist in a camshaft chamber is insufficient, and the lubrication of the cam of the camshaft could be hindered.

An object of the present invention is to provide a shaft-less engine in which lubrication of a cam of a camshaft is not hindered in a case where a cylinder block is shared by engines having different specifications and distinguished by presence or absence of a predetermined rotation shaft.

### Solutions to the Problems

A main configuration of the present invention is as follows.

An engine includes a cylinder block front wall (2a), a camshaft chamber front wall (2b) as exemplified in FIG. 2, and a camshaft chamber (2c) provided on a rear side of the camshaft chamber front wall (2b) as exemplified in FIG. 3 with an extending direction of a crankshaft (1) defined as a front-rear direction, one side in the front-rear direction defined as a front side, and another side in the front-rear direction defined as the rear side as exemplified in FIG. 1, in which a camshaft (5) is housed in the camshaft chamber (2c),
the camshaft chamber front wall (2b) includes a front bearing hole (2d) of the camshaft (5) and a front hole (2e) disposed below the front bearing hole (2d) as exemplified in FIG. 3, and a camshaft chamber rear wall (2f) includes a rear hole (2g) concentric with the front hole (2e),
the cylinder block front wall (2a) includes an oil supply passage (8) in which a passage outlet (8a) is formed on an inner peripheral surface of the front hole (2e) as exemplified in FIG. 2, a fitting component (9) that covers the passage outlet (8a) of the oil supply passage (8) is fitted in the front hole (2e) of the camshaft chamber front wall (2b), and the fitting component (9) includes a camshaft oil jet hole (9a) that injects engine oil (7) from the oil supply passage (8) to the camshaft (5) as exemplified in FIG. 3.

### EFFECTS OF THE INVENTION

The present invention has the following effects.

<<Effects>> Even in a shaft-less engine, lubrication of a cam (5a) of the camshaft (5) is not hindered in a case where a cylinder block (2) is shared by engines having different specifications and distinguished by presence or absence of a predetermined rotation shaft (R).

As exemplified in FIG. 10, by bridging a predetermined rotation shaft (R) below the camshaft (5) via front and rear bearings (30d) and (30e) internally fitted into the front hole (2e) and the rear hole (2g) without a fitting component (9), a shaft-equipped engine can be manufactured. Therefore, the cylinder block (2) can be shared with a shaft-equipped engine.

Then, as exemplified in FIG. 3, since the engine oil (7) is injected from the oil jet hole (9a) to the camshaft (5), the lubrication of a cam (5a) of the camshaft (5) is not hindered although the engine is a shaft-less engine without the predetermined rotation shaft (R) (exemplified in FIG. 10) that splashes the engine oil (7) by rotation.

In this manner, in even a shaft-less engine, the lubrication of the cam (5a) of the camshaft (5) is not hindered in a case where the cylinder block (2) is shared by engines having different specifications and distinguished by the presence or absence of the predetermined rotation shaft (R).

### BRIEF DESCRIPTION OF THE DRAWINGS

FIG. 1 is a partially cutaway right side view of a main part of a shaft-less engine according to an embodiment of the present invention.

FIG. 2 is a sectional view taken along line II-II in FIG. 1.

FIG. 3 is a sectional view taken along line III-III in FIG. 2.

FIG. 4 is a sectional view taken along line IV-IV in FIG. 1.

FIG. 5 is a right side view of the engine in FIG. 1.

FIG. 6 is a left side view of the engine in FIG. 1.

FIG. 7 is a front view of the engine in FIG. 1.

FIG. 8 is a rear view of the engine in FIG. 1.

FIG. 9 is a plan view of the engine in FIG. 1.

FIG. 10 is a partially cutaway right side view of a main part of a shaft-equipped engine that shares a cylinder block with the engine in FIG. 1.

FIG. 11 is a sectional view taken along line XI-XI in FIG. 10.

FIG. 12 is a sectional view taken along line XII-XII in FIG. 10.

### EMBODIMENTS OF THE INVENTION

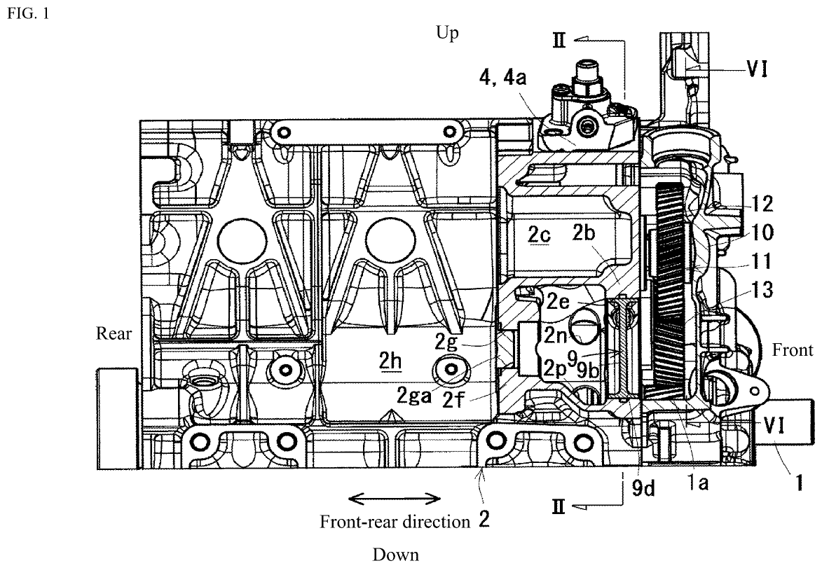

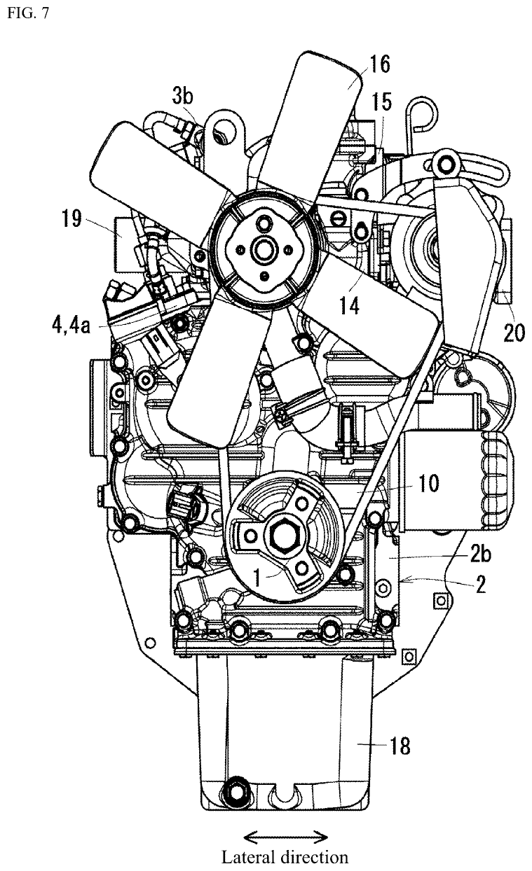

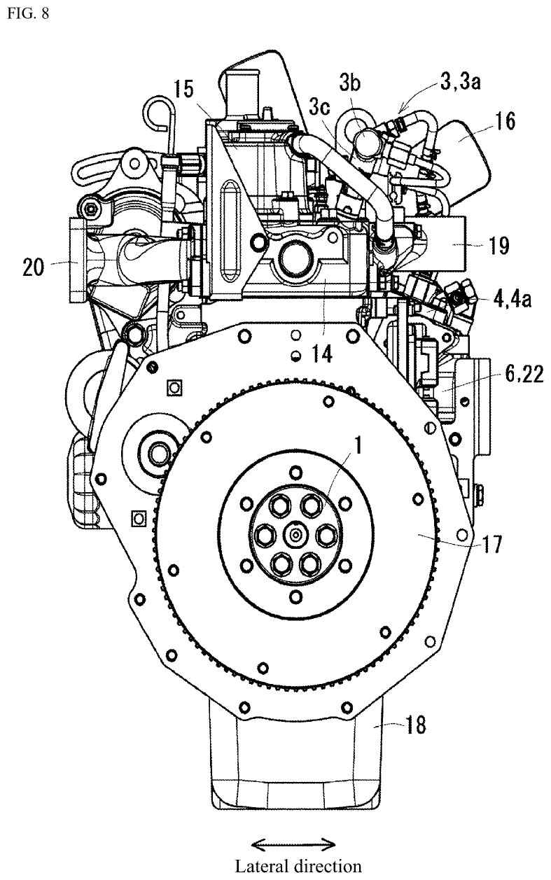

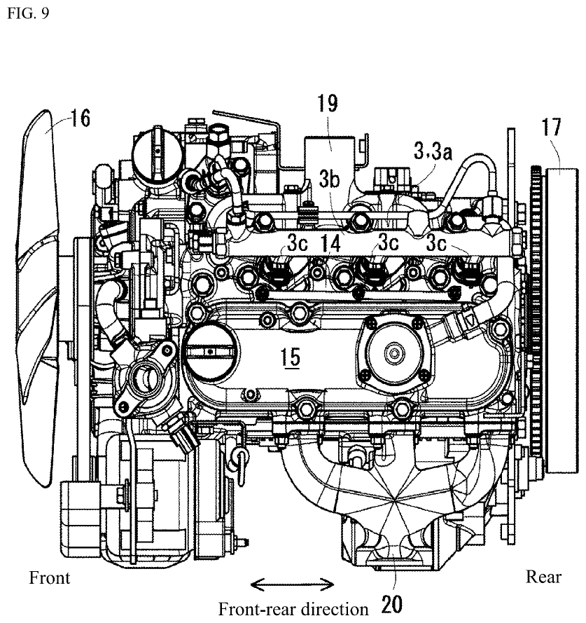

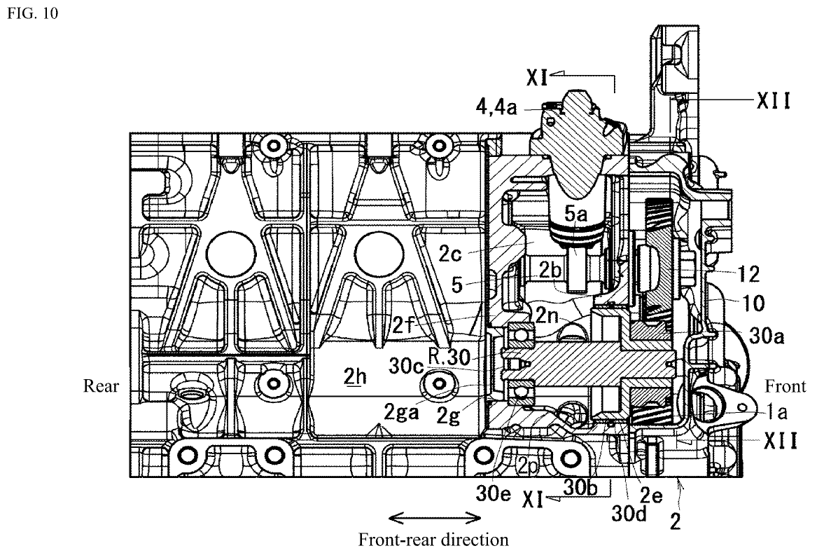

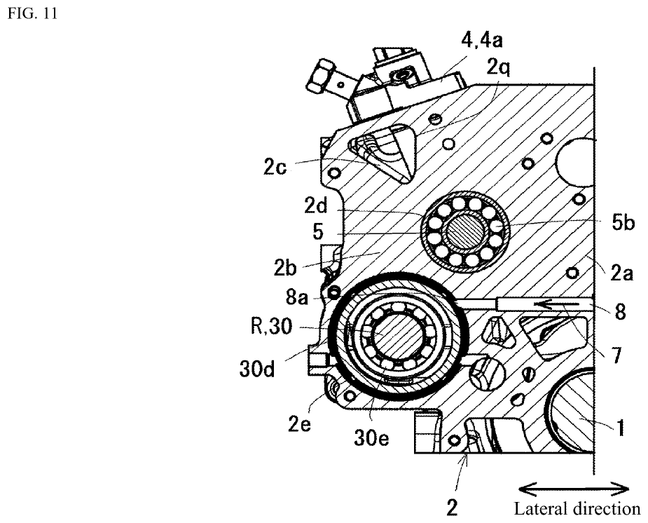

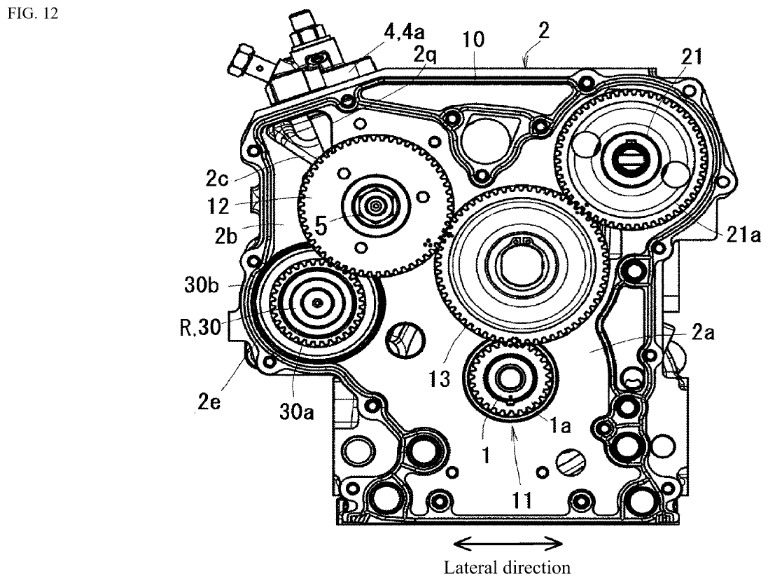

FIGS. 1 to 9 are diagrams for describing a shaft-less engine according to an embodiment of the present invention, and FIGS. 10 to 12 show a shaft-equipped engine that shares a cylinder block with the shaft-less engine. In this embodiment, a common rail type vertical straight multi-cylinder (three-cylinder) diesel engine will be described.

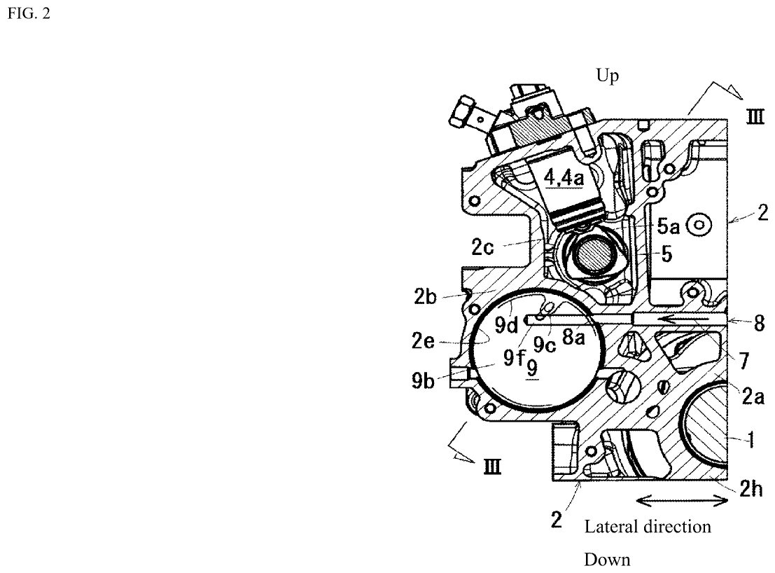

As shown in FIG. 1, an extending direction of a crankshaft is a front-rear direction, one side in the front-rear direction is a front side, another side is a rear side, and as shown in FIG. 2, a width direction of the engine orthogonal to the front-rear direction is a lateral direction.

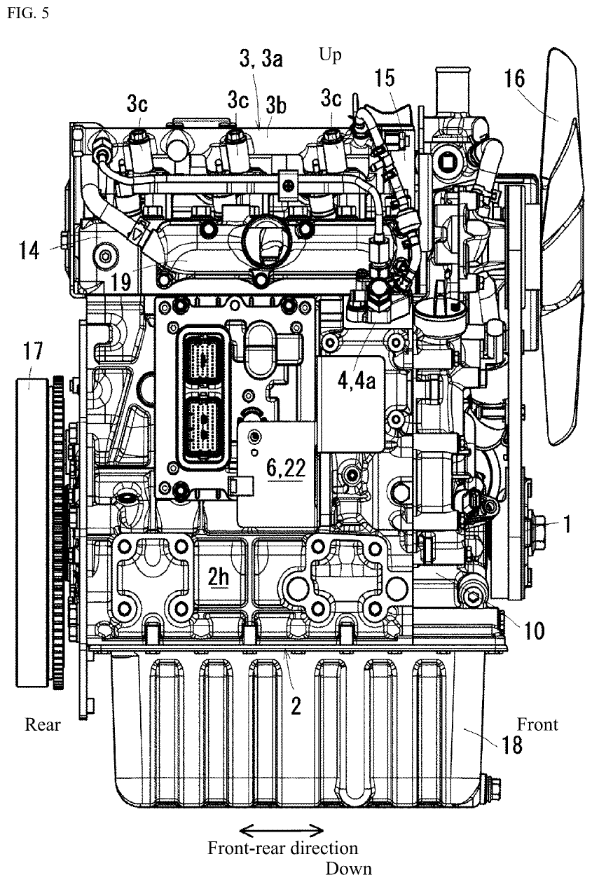

The shaft-less engine shown in FIG. 5 includes a cylinder block (2), a cylinder head (14) assembled to an upper portion of the cylinder block (2), a cylinder head cover (15) assembled to an upper portion of the cylinder head (14), a timing transmission case (10) assembled to a front portion of the cylinder block (2), an engine cooling fan (16) disposed on a front side of the timing transmission case (10), a flywheel (17) disposed at a rear portion of the cylinder block (2), and an oil pan (18) assembled to a lower portion of the cylinder block (2). A crankcase (2h) is configured in a lower portion of the cylinder block (2).

The crankcase (2h) houses a crankshaft (1).

The engine includes an intake device, a fuel supply device, and an exhaust device.

As shown in FIG. 5, the intake device includes an intake manifold (19) assembled to one lateral side of the cylinder head (14). Air in the intake manifold (19) is sucked into each cylinder (not shown) from an intake port (not shown) by opening an intake valve (not shown).

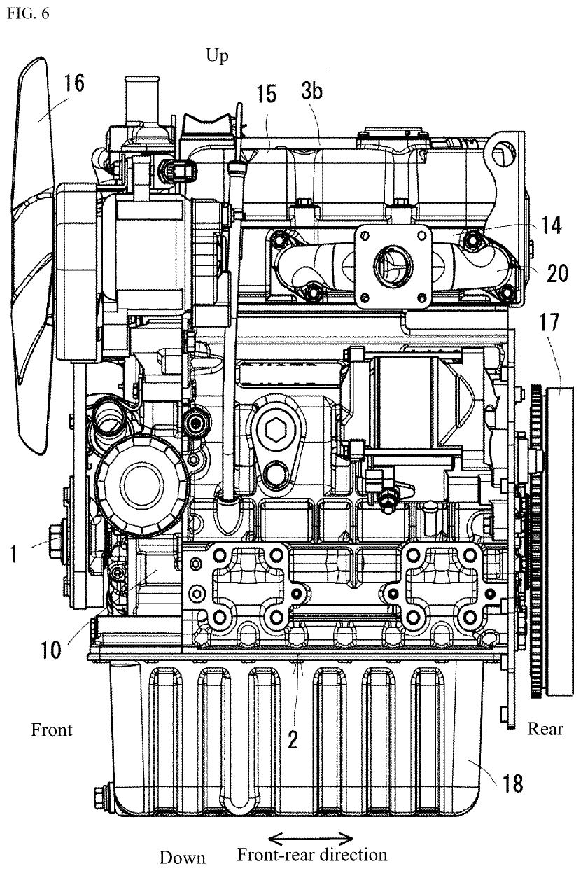

As shown in FIG. 6, the exhaust device includes an exhaust manifold (20) assembled to another lateral side of the cylinder head (14). Exhaust of each cylinder is discharged from an exhaust port (not shown) to an exhaust manifold (20) by opening an exhaust valve (not shown).

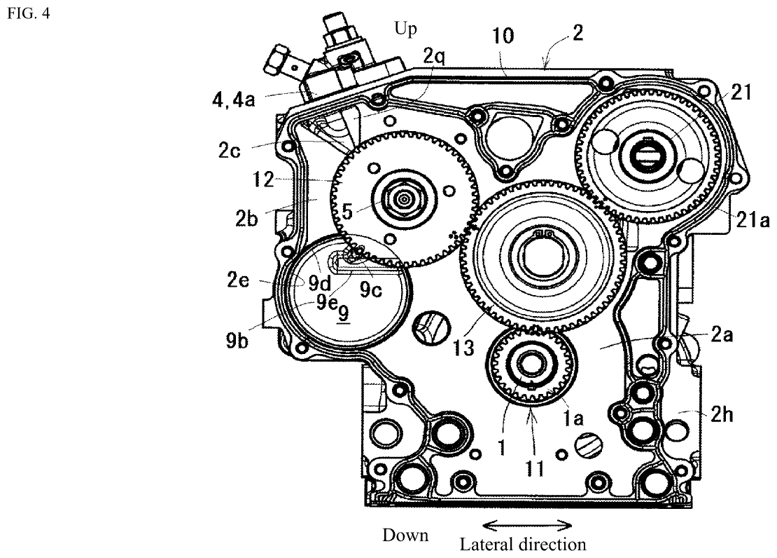

The intake valve and the exhaust valve are driven to open and close by a cam (not shown) of a valve camshaft (21) shown in FIG. 4.

As shown in FIG. 5, the fuel supply device includes a fuel pressure-feed pump (4) and a fuel injection device (3).

A fuel injection device (3) is a common rail type fuel injection device (3a), and includes a common rail (3b) and a fuel injector (3c) that injects liquid fuel accumulated in the common rail (3b) into each cylinder.

The fuel pressure-feed pump (4) that supplies the liquid fuel to the common rail (3b) is a fuel supply pump (4a).

An electromagnetic valve of the fuel injector (3c) shown in FIG. 5 is opened for a predetermined period at a predetermined timing by control of an engine ECU (22) on the basis of detection of an accelerator position and an engine load, and a predetermined amount of the liquid fuel is injected from the fuel injector (3c) into each cylinder at a predetermined timing. The engine ECU (22) is attached to an intake-side side surface of the cylinder block (2).

The ECU is an abbreviation of an electronic control unit, and a microcomputer is used.

The engine ECU (22) functions as a control device (6) of the engine.

The timing of opening and closing the electromagnetic valve of the fuel injector (3c) shown in FIG. 5 is set on the basis of a crank angle of the crankshaft (1) and a cam position of the valve camshaft (21).

The accelerator position is detected by an accelerator position sensor (not shown).

The engine load is calculated by the engine ECU (22) by comparison of the accelerator position with an engine speed.

The engine speed and the crank angle of the crankshaft (1) are detected by an electromagnetic pickup (not shown) that detects unevenness of an outer periphery of a crankshaft disk (not shown) attached to the crankshaft (1), and the cam position is detected by a cam position sensor (not shown) that detects unevenness of an outer periphery of a camshaft disk (not shown) attached to the valve camshaft (21) shown in FIG. 4.

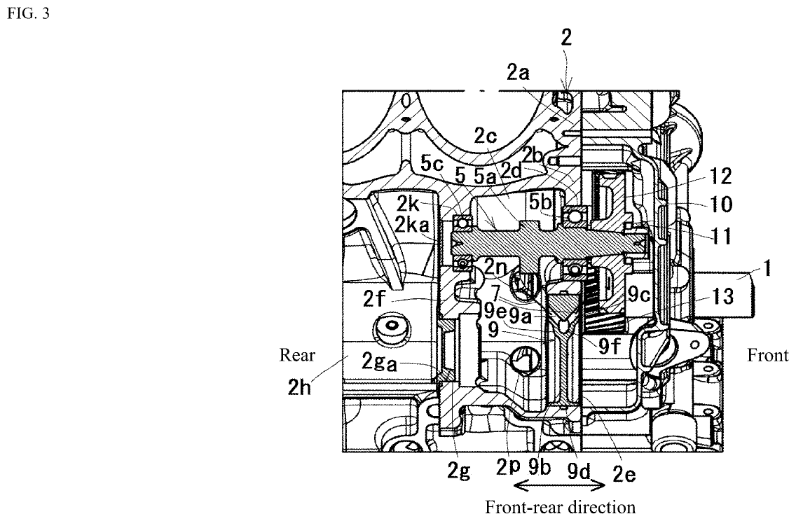

As shown in FIG. 2, the engine includes a cylinder block front wall (2a), a camshaft chamber front wall (2b), and a camshaft chamber (2c) provided on a rear side of the camshaft chamber front wall (2b) as shown in FIG. 3, and a camshaft (5) is housed in the camshaft chamber (2c).

As shown in FIG. 2, the camshaft (5) is a pump drive camshaft (5) that drives the fuel pressure-feed pump (4).

As shown in FIG. 3, the camshaft chamber front wall (2b) includes a front bearing hole (2d) of the camshaft (5) and a front hole (2e) disposed below the front bearing hole (2d), and a camshaft chamber rear wall (2f) includes a rear hole (2g) concentric with the front hole (2e).

As shown in FIG. 10, by bridging a predetermined rotation shaft (R) below the camshaft (5) via front and rear bearings (30d) and (30e) internally fitted into the front hole (2e) and the rear hole (2g) without a fitting component (9), a shaft-equipped engine can be manufactured. Therefore, the cylinder block (2) can be shared between the shaft-less engine and the shaft-equipped engine.

As shown in FIG. 2, the cylinder block front wall (2a) includes an oil supply passage (8) in which a passage outlet (8a) is formed on an inner peripheral surface of the front hole (2e), a fitting component (9) that covers the passage outlet (8a) of the oil supply passage (8) is fitted in the front hole (2e) of the camshaft chamber front wall (2b), and as shown in FIG. 3, the fitting component (9) includes a camshaft oil jet hole (9a) that injects engine oil (7) from the oil supply passage (8) to the camshaft (5).

As shown in FIG. 3, since the engine oil (7) is injected from the camshaft oil jet hole (9a) to the camshaft (5), lubrication of a cam (5a) of the camshaft (5) is not hindered although the engine is a shaft-less engine without the predetermined rotation shaft (R) (shown in FIG. 10) that splashes the engine oil (7) by rotation.

In this manner, even in a shaft-less engine, the lubrication of the cam (5a) of the camshaft (5) is not hindered in a case where the cylinder block (2) is shared by engines having different specifications and distinguished by presence or absence of the predetermined rotation shaft (R).

As shown in FIG. 2, the camshaft (5) includes the cam (5a) that drives the fuel pressure-feed pump (4) inserted into the camshaft chamber (2c).

The predetermined rotation shaft (R) is a PTO shaft (30). PTO is an abbreviation of power take off, and refers to taking out a work output from an engine.

The predetermined rotation shaft (R) may be a governor shaft or a balancer shaft other than the PTO shaft (30).

As shown in FIG. 4, in this engine, the camshaft chamber front wall (2b) protrudes laterally from the cylinder block front wall (2a), and as shown in FIG. 2, the camshaft chamber (2c) is formed laterally of the cylinder block (2).

As shown in FIG. 3, in this engine, the camshaft oil jet hole (9a) is provided in an inner diameter portion (9b) along an inner diameter of the fitting component (9).

In this engine, a degree of freedom in setting an arrangement and an orientation of the camshaft oil jet hole (9a) is high, and an injection direction and an injection position of the engine oil (7) from the camshaft oil jet hole (9a) can be optimized.

As shown in FIG. 3, the engine includes a camshaft input gear (12) of the camshaft (5) on the front side of the camshaft chamber front wall (2b), and as shown in FIGS. 3 and 4, the fitting component (9) includes a gear oil jet hole (9c) that injects the engine oil (7) from the oil supply passage (8) to the camshaft input gear (12).

In this engine, since the engine oil (7) from the oil supply passage (8) is injected from the gear oil jet hole (9c) to the camshaft input gear (12), lubricity of the camshaft input gear (12) is high.

As shown in FIGS. 3 and 4, in this engine, the camshaft oil jet hole (9a) and the gear oil jet hole (9c) are provided in the inner diameter portion (9b) along the inner diameter of the fitting component (9).

In this engine, a degree of freedom in setting an arrangement and an orientation of the camshaft oil jet hole (9a) and the gear oil jet hole (9c) is high, and an injection direction and an injection position of the engine oil (7) from the camshaft oil jet hole (9a) and the gear oil jet hole (9c) can be optimized.

As shown in FIG. 3, in this engine, the fitting component (9) includes a cylindrical collar (9d) fitted in the front hole (2e), the disk-shaped inner diameter portion (9b) along an inner diameter of the collar (9d), a raised portion (9e) extending from an inner peripheral surface of the collar (9d) along front and back surfaces of the inner diameter portion (9b), an oil introduction passage (9f) provided in the raised portion (9e) and communicating with the oil supply passage (8) shown in FIG. 2, and the camshaft oil jet hole (9a) and the gear oil jet hole (9c) led out from the oil introduction passage (9f) as shown in FIG. 3.

As shown in FIG. 2, in this engine, the cam (5a) of the camshaft (5) includes three cam noses at 120° intervals in a circumferential direction of the camshaft (5).

With the three cam noses, the fuel supply pump (4a) pumps the liquid fuel to the common rail (3b) at every crank angle of 720° during one combustion cycle at a crank angle of 240°.

As shown in FIG. 3, the camshaft (5) is borne by a camshaft front bearing (5b) internally fitted into the front bearing hole (2d) and a camshaft rear bearing (5c) internally fitted into a rear bearing hole (2k) concentric with the camshaft front bearing (5b), and is installed in the camshaft chamber (2c).

The rear bearing hole (2k) is formed in the camshaft chamber rear wall (2f), and is closed by a camshaft rear plug (2ka).

The rear hole (2g) is closed by a rear hole plug (2ga).

As shown in FIG. 3, in this engine, the camshaft chamber (2c) includes upper and lower oil mist introduction ports (2n) and (2p) communicating with the inside of the crankcase (2h) and an oil mist outlet port (2q) communicating with the inside of the timing transmission case (10) shown in FIG. 4, oil mist of the engine oil (7) splashed up to the crankshaft (1) in the crankcase (2h) is introduced into the camshaft chamber (2c) from the upper and lower oil mist introduction ports (2n) and (2p) shown in FIG. 3, the cam (5a) of the pump drive camshaft (5) is lubricated, the oil mist in the camshaft chamber (2c) is led out into the timing transmission case (10) from the oil mist outlet port (2q) shown in FIG. 4, and a timing transmission gear train (11) such as the camshaft input gear (12) is lubricated.

As shown in FIG. 4, in this engine, the timing transmission case (10) covers the cylinder block front wall (2a) and the camshaft chamber front wall (2b) from the front side, and the timing transmission gear train (11) housed in the timing transmission case (10) includes a crank gear (la) attached to a crankshaft (1), an idle gear (13) meshed with the crank gear (la), and the camshaft input gear (12) and a valve camshaft input gear (21a) that are meshed with the idle gear (13).

Gear ratios of the crank gear (la) to the camshaft input gear (12) and the valve camshaft input gear (21a) of the pump drive camshaft (5) are both two, and the pump drive camshaft (5) and the valve camshaft (21) make one rotation while the crankshaft (1) makes two rotations.

The configuration of a shaft-equipped engine that shares the cylinder block (2) with a shaft-less engine without the predetermined rotation shaft (R) is as follows. As shown in FIGS. 10 to 12, the engine includes the PTO shaft (30) as the predetermined rotation shaft (R). The PTO shaft (30) includes a PTO shaft input gear (30a), a journal portion (30b), and a slit-shaped PTO shaft output unit (30c) at a rear end. The PTO shaft (30) is borne by the front bearing (30d) fitted in the front hole (2e) and the rear bearing (30e) fitted in the rear hole (2g), and is installed in a lower portion of the camshaft chamber (2c).

PTO output from the PTO shaft (30) is performed by extracting the rear hole plug (2ga) from the rear hole (2g) and connecting an input unit of a work device such as a hydraulic pump to the PTO shaft output unit (30c).

The predetermined rotation shaft (R) may be a governor shaft or a balancer shaft other than the PTO shaft (30).

Other structures are the same as the structure of the shaft-less engine shown in FIGS. 1 to 9. In FIGS. 10 to 12, the same elements as in FIGS. 1 to 9 are denoted by the same reference signs as in FIGS. 1 to 9.

### DESCRIPTION OF REFERENCE SIGNS

(1): Crankshaft
(2a): Cylinder block front wall
(2b): Camshaft chamber front wall
(2c): Camshaft chamber
(2d): Front bearing hole
(2e): Front hole
(2f): Camshaft chamber rear wall
(2g): Rear hole
(5): Camshaft
(7): Engine oil
(8): Oil supply passage
(8a): Passage outlet
(9): Fitting component
(9a): Camshaft oil jet hole
(9b): Inner diameter portion
(9c): Gear oil jet hole
(12): Camshaft input gear

1. An engine comprising:
a cylinder block front wall; a camshaft chamber front wall; and a camshaft chamber provided on a rear side of the camshaft chamber front wall with an extending direction of a crankshaft defined as a front-rear direction, one side in the front-rear direction defined as a front side, and another side in the front-rear direction defined as the rear side, wherein a camshaft is housed in the camshaft chamber,
the camshaft chamber front wall includes a front bearing hole of the camshaft and a front hole disposed below the front bearing hole, and a camshaft chamber rear wall includes a rear hole concentric with the front hole,
the cylinder block front wall includes an oil supply passage in which a passage outlet is formed on an inner peripheral surface of the front hole, a fitting component that covers the passage outlet of the oil supply passage is fitted in the front hole of the camshaft chamber front wall, and the fitting component includes a camshaft oil jet hole that injects engine oil from the oil supply passage to the camshaft.

2. The engine according to claim 1, wherein the camshaft oil jet hole is provided in an inner diameter portion along an inner diameter of the fitting component.

3. The engine according to claim 1, further comprising:
a camshaft input gear of the camshaft on the front side of the camshaft chamber front wall,
wherein the fitting component includes a gear oil jet hole that injects the engine oil from the oil supply passage to the camshaft input gear.

4. The engine according to claim 3, wherein the camshaft oil jet hole and the gear oil jet hole are provided in the inner diameter portion along the inner diameter of the fitting component.
